(19) United States
(12) Patent Application Publication
(10) Pub. No.: US 2003/0121362 A1
(43) Pub. Date: Jul. 3, 2003

(54) Sectional curtain for convering machine parts

(76) Inventor: Willy Goellner, Rockford, IL (US)

Correspondence Address: Rocco S Barrese, Dilworth & Barrese, 333 Earle Ovington Boulevard, Uniondale, NY, 11553, US

(21) Appl. No.: 10/169,513

(22) PCT Filed: Dec. 4, 2001
(86) PCT No.: PCT/EP01/14166

(30) Foreign Application Priority Data
Dec. 4, 2000 (DE) 100601391

(51) Int. Cl. F16P 1/00; G05G 25/00

(52) U.S. Cl. 74/608

(57) ABSTRACT

A linked apron serves to cover machine parts, in particular machine tool parts. It has a plurality of links (9, 10) connected to one another in a hinged manner. To increase the speed on pulling out and/or moving in the linked apron, individual links (9) of the linked apron (2, 3) are connected by a collapsible grid (14, 15, 16, 17) (FIG. 3).

The invention relates to a linked apron to cover machine parts, in particular to cover machine tool parts, having a plurality of links connected to one another in a hinged manner.

Such a linked apron is known from DE-GM 295 00 395. Such linked aprons, which can also be termed fold-like protective covers, are characterised by high shape stability. They can be used to cover machine parts, machine tool parts and other apparatuses of all kinds. The number of links is based on the size of the region to be covered. The links, which are substantially designed as elongate strips or lamellas, are connected to one another in a hinged manner.

The linked aprons can be used in a manner such that an end link is connected to the machine or machine tool or other apparatus, while the other end link is connected to a moving machine part or apparatus part or machine tool part, in particular to a spindle frame of a machine tool.

The problem is intended to be solved by the invention of increasing the speed with which the linked apron can be moved out and/or moved in.

The solution of this problem is provided by a linked apron in accordance with the preamble of claim 1 by the characterising features of this claim, that is in that individual links of the linked apron are connected to a collapsible grid. It is advantageous to connect the individual links of the linked apron with the intermediate stud of the collapsible grid. The connection is preferably made by a screw connection. However, other kinds of connection are also possible. Further links are present between the links with which the linked apron is connected to the collapsible grid or to the intermediate stud of the collapsible grid and a pulling out and moving in of the linked apron is made possible by these.

The stability of the linked apron is increased by the collapsible grid. In particular with linked aprons which have relatively long links (strips, lamellas), there is the risk that the links do not remain parallel to one another during pulling out or moving in, but mutually “warp” one another. The guiding and stability of the linked apron is increased by the collapsible grid so that the linked apron can be pulled out and/or moved in at higher speeds.

Advantageous further developments of the invention are described in the dependent claims.

The links of the linked apron can be connected to one another in a hinged manner by coupling elements. The coupling elements are preferably elastic. They are preferably made of an elastic material, preferably of an elastic plastic. It is of particular advantage to use the coupling elements known from DE-GM 295 00 395 which are designed such that successive links or lamellas alternately fold in when the linked apron or protective cover is pushed together. For this purpose, the coupling elements can have a larger material accumulation on one side which results in the coupling elements folding in on their own in the opposite direction, that is in that direction in which only a smaller material accumulation is present at the coupling element.

Individual links of the linked apron can be rigidly connected to one another. In this way, the links can be enlarged and adapted to the respective requirements in a simple manner while using uniform, relatively small elements.

Another advantageous further development is characterised in that the linked apron is connected to a plurality of collapsible grids. The stability is further increased thereby with long links. It is particularly advantageous to provide two collapsible grids. It is in many cases possible thereby to achieve a very good stability with a relatively limited effort.

A guide element can be provided at the linked apron. The guide element preferably cooperates with a guide track.

It is advantageous for the guide element to lie on the side of the linked apron facing away from the links. In this way, the guide element and the associated guide track can be placed in the “protected” region, that is “behind” the linked apron.

The guide element preferably has rolls.

The linked apron can be provided with a further cover apparatus. This further cover apparatus can be a Venetian blind, but also other cover apparatuses such as bellows or similar. It is advantageous for the direction of movement of the further cover apparatus to extend perpendicular to the direction of movement of the linked apron. It is hereby possible to enable an x-y movement or an x-z movement of the spindle or spindle box of a machine tool, for example a movement in the horizontal and vertical directions of a spindle with a horizontal rotational axis.

The invention further relates to a module or cover module for a machine, in particular for a machine tool, but also for other apparatuses of all kinds. The module or cover module has a frame and a linked apron in accordance with the invention. The module can be connected to the machine or machine tool or apparatus. A particularly simple installation is hereby possible. It is particularly advantageous for the module to have a further cover apparatus in addition to the linked apron, with this further cover apparatus preferably being movable in a direction perpendicular to the direction of movement of the linked apron. The directions of movement of the linked apron and/or of the further cover apparatus preferably lie in the plane of the module or of the cover module.

The module or cover module preferably has a base plate. The base plate is preferably connectable to the machine or to the machine tool or to another apparatus. The base plate is preferably connected or connectable to the frame of the module.

An embodiment of the invention will be described below in detail with reference to the enclosed drawing. There is shown in the drawing:

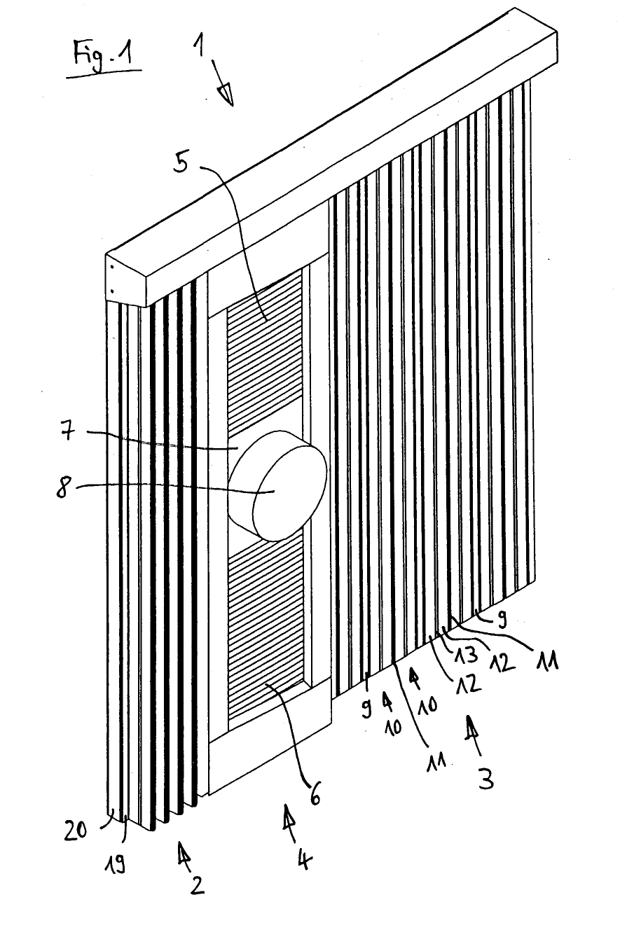

FIG. 1 a cover module with two linked aprons and a Venetian blind in a perspective view from the front;

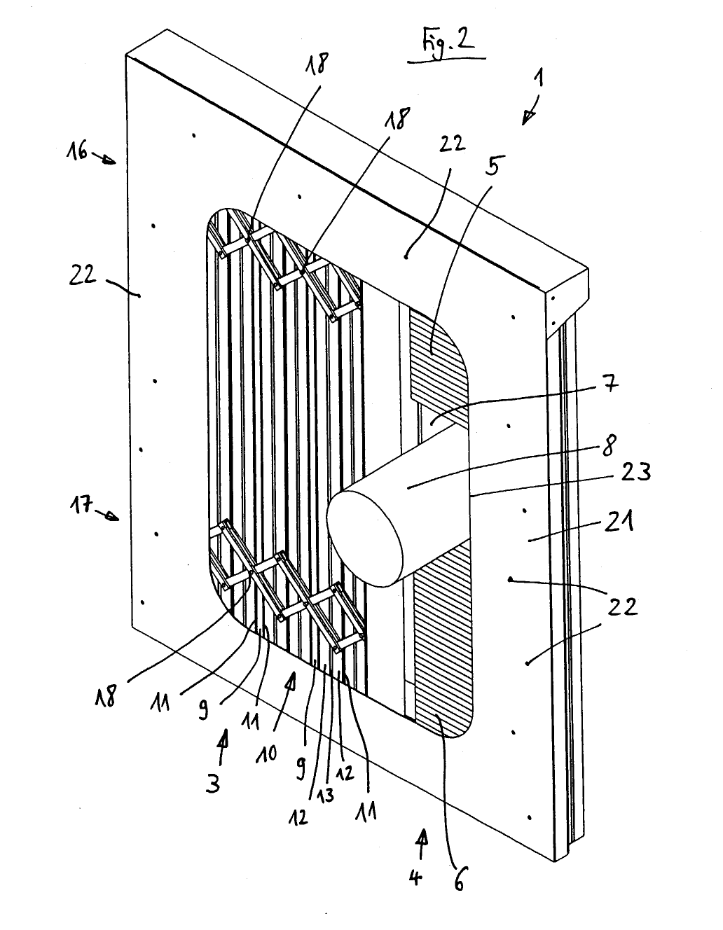

FIG. 2 the cover module in accordance with FIG. 1 in a perspective view from behind;

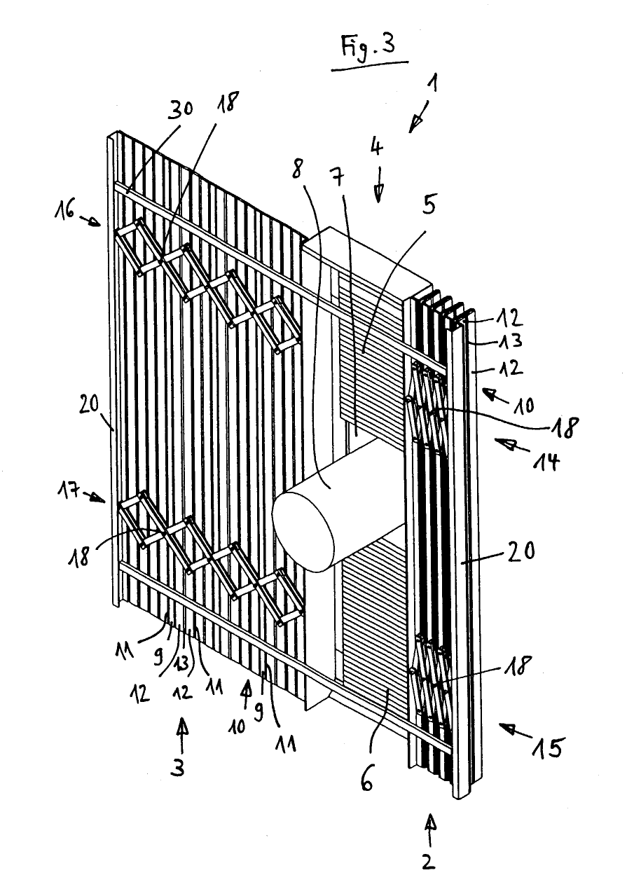

FIG. 3 the cover module in accordance with FIGS. 1 and 2 in a perspective view corresponding to FIG. 2 with the base plate removed;

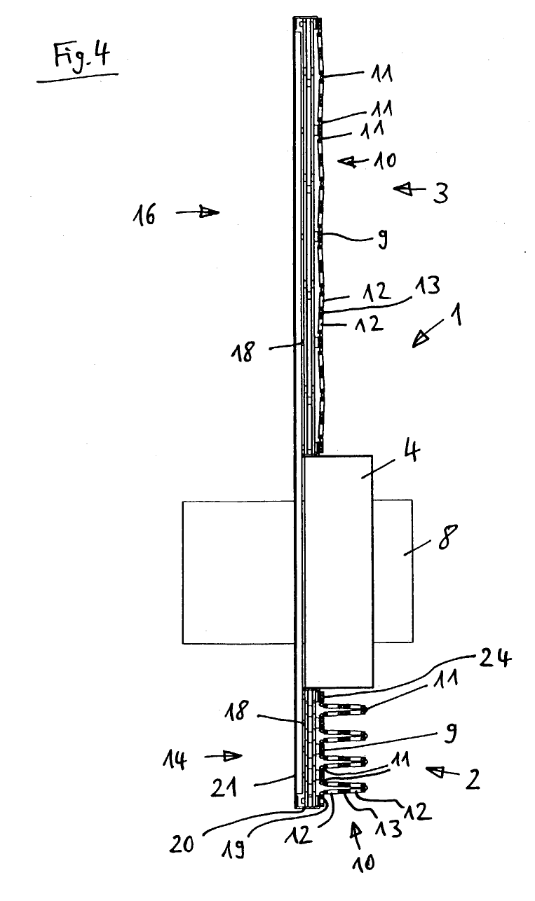

FIG. 4 a horizontal section through the cover module in accordance with FIGS. 1-3;

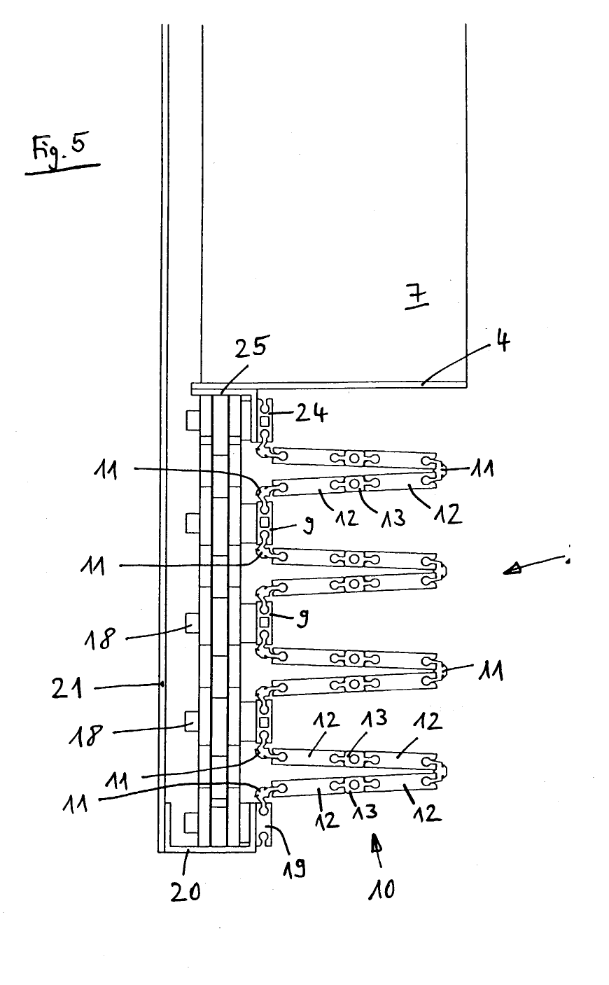

FIG. 5 the lower part of FIG. 4 in an enlarged representation;

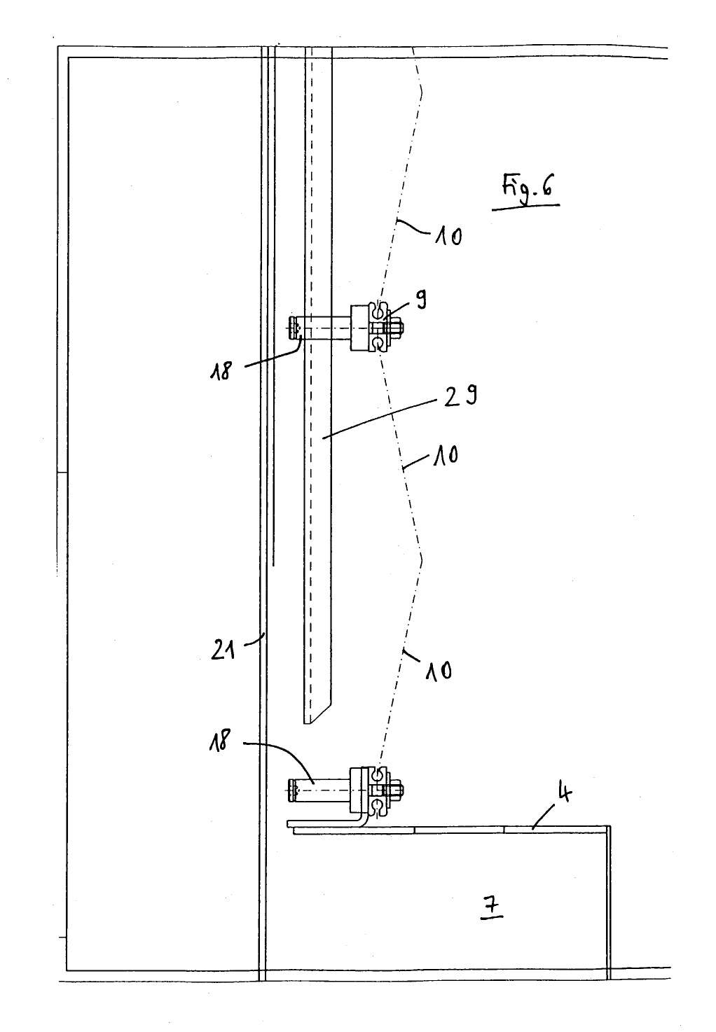

FIG. 6 the part of FIG. 4 upwardly adjoining the spindle box in an enlarged representation;

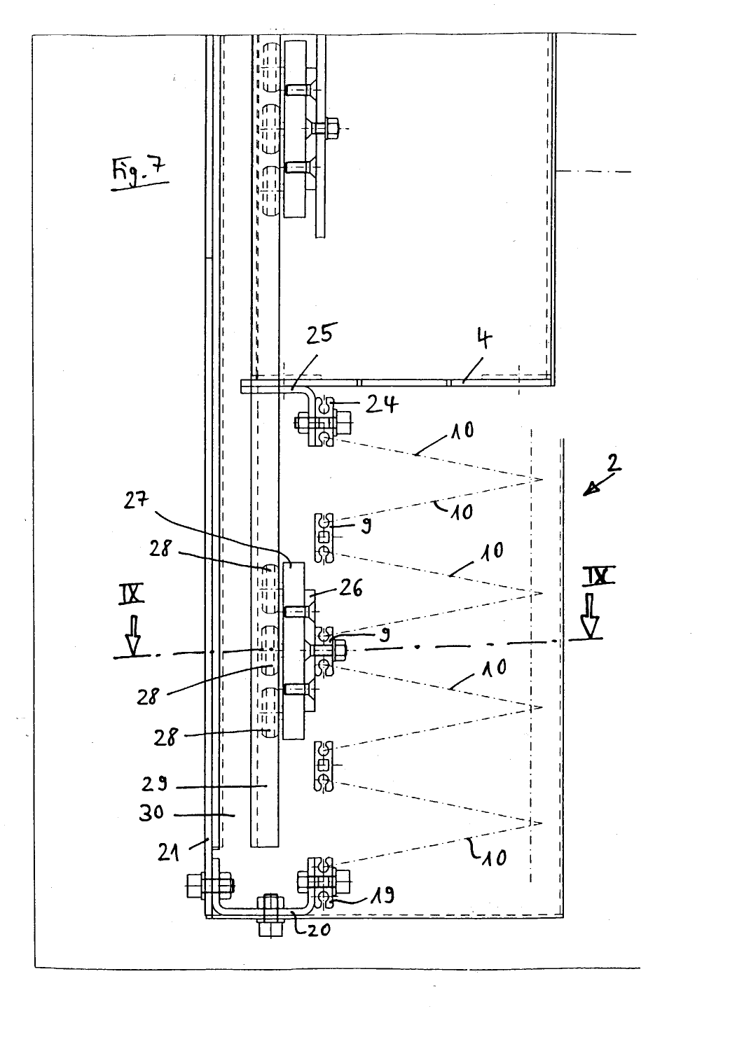

FIG. 7 a horizontal section of the cover module in the plane of the guide elements;

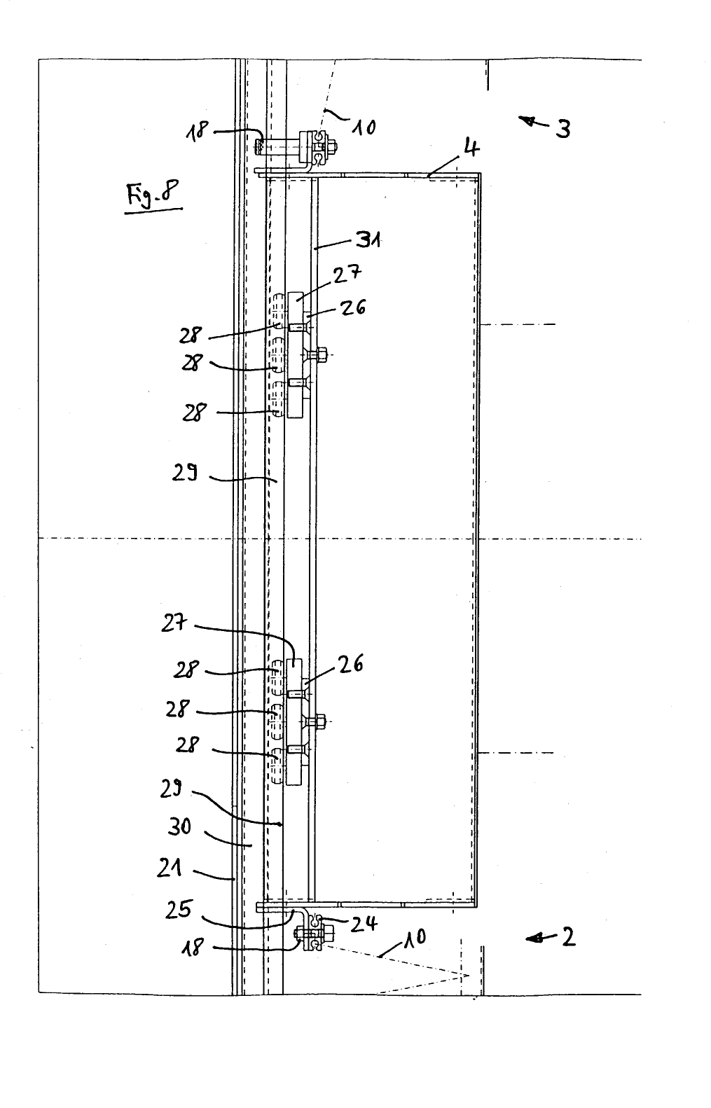

FIG. 8 a horizontal section through the spindle box in the plane corresponding to FIG. 7; and

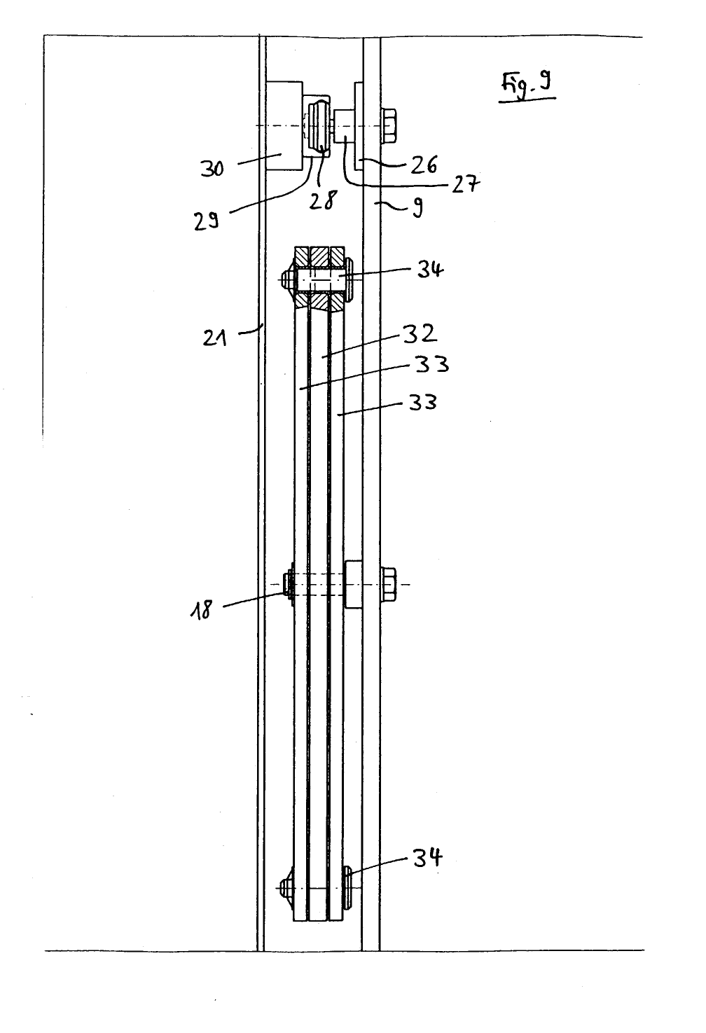

FIG. 9 a section along the line IX-IX in FIG. 7.

The cover module shown perspectively in FIGS. 1 to 3 has a first linked apron 2 and a second linked apron 3 between which a spindle frame 4 is arranged in which a further cover apparatus, namely a Venetian blind, is provided which consists of a first (upper) Venetian blind 5 and a second (lower) Venetian blind 6 which receive the spindle box 7 with the spindle 8 between them. The direction of movement of the linked aprons 2 and 3 is horizontal; the direction of movement of the Venetian blinds 5 and 6 extends perpendicular thereto, namely vertically. The spindle 8, which has a horizontal axis of rotation, is movable in the x-z direction.

The linked aprons 2, 3 consist of links connect to one another in a hinged manner, said links being central elements 9 and unfolding elements 10 which are connected to one another in a hinged manner by coupling elements 11 of elastic plastic. Each unfolding element 10 consists in turn of two base elements 12 which are rigidly connected to one another by a respective connection element 13 (see in particular FIG. 5 in this respect).

The linked apron 2 is connected to an upper collapsible grid 14 and a lower collapsible grid 15. The linked apron 3 is connected in a corresponding manner to an upper collapsible grid 16 and a lower collapsible grid 17. In this connection, the intermediate studs (central intermediate studs) 18 are respectively connected to a central element 9 of the linked apron. The collapsible grids 14 and 15 or 16 and 17 respectively lie in the upper and lower regions respectively of the linked aprons 2 or 3. A high degree of stability is hereby achieved with a relatively low effort. The collapsible grids stabilise the links of the linked aprons such that high speeds can be achieved on the pulling out and in the moving in of the linked aprons.

The outer edge elements of the linked apron are connected to a frame of the cover module 1. As is shown in FIG. 5, the outer edge element 19 of the linked apron 2 is connected, for example screwed, to the frame 20 of the cover module 1. The frame 20 has a U-shaped section. The edge element 19 is screwed to a limb of this section. The other limb of the frame 20 is connected to a base plate 21. Screw drillings 22 are provided at the base plate 21 in the manner visible from FIG. 2 and lie inside the frame 20. The base plate 21, and with it the whole cover module 1, can be connected through these to a machine tool or other machine or other apparatus. Other connection elements can also be provided instead of the screw drillings 22. The base plate 21 has a central, substantially rectangular cut-out 23 in the manner visible from FIG. 2 through which the spindle 8 engages and whose size is matched to the movement requirements of the spindle 8.

The linked aprons are connected at their inner ends to the spindle frame 4. As can be seen from FIG. 5, the inner edge element 24 of the linked apron 2 is connected to the limb of an angle iron 25 which is in turn secured to the spindle frame 4.

The guide of the linked aprons and of the spindle frame is shown in the FIGS. 7 to 9. A metal sheet 26 is screwed to the central intermediate element 9 of the linked apron 2 and is in turn connected by two countersunk screws to a guide element (roll-on guide element) 27. Three rolls 28 are rotatably mounted on the guide element 27, which can also be termed a carriage. The rolls rest on a guide track 29 which is designed as a C-shaped section. The guide track 29 is secured to a transverse rail 30 which is in turn connected to the base plate 21 and the frame 20 (see also FIG. 3 in this respect).

The guide lies on the side of the linked apron or of the central elements 9 facing away from the unfolding elements 10. The guide is therefore located “behind” the cover provided by the linked apron. It is protected against external influences there.

The spindle frame 4 is guided in a corresponding manner. The guides of the spindle frame 4 are shown in FIG. 8. The spindle frame 4 has an installation rail (or installation plate) 31 to which two metal sheets 26 are screwed which are in turn connected by two respective countersunk screws to a respective guide element 27. Three rolls 28 each are rotatably mounted on the guide elements 27 and roll off on the guide track 29.

FIG. 9 shows a vertical section through the central intermediate element 9 of the linked apron 2. The intermediate stud 18 is connected, namely screwed, to the intermediate element 9. There can further be seen in FIG. 9 a central shear rod 32 and two outer shear rods 33 and outer intermediate studs 34.

1. A linked apron to cover machine parts, in particular machine tool parts, having a plurality of elements (9, 10) linked together in a hinged manner, characterised in that
individual elements (9) of the linked apron (2, 3) are connected by a collapsible grid (14, 15, 16, 17).

2. A linked apron in accordance with claim 1, wherein the elements (9, 10) of the linked apron (2, 3) are connected to one another in a hinged manner by coupling elements (11).

3. A linked apron in accordance with claim 2, wherein the coupling elements (11) are elastic.

4. A linked apron in accordance with any of the preceding claims, wherein individual elements (12) of the linked apron are rigidly connected to one another.

5. A linked apron in accordance with any of the preceding claims, wherein the linked apron (2, 3) is connected to a plurality of, preferably two, collapsible grids (14, 15; 16, 17).

6. A linked apron in accordance with any of the preceding claims, wherein a guide element (27) is provided at the linked apron (2, 3).

7. A linked apron in accordance with claim 6, wherein the guide element (27) lies on the side of the linked apron (2, 3) facing away from the links (9, 10).

8. A linked apron in accordance with either of claims 6 or 7, wherein the guide element (27) has rolls (28).

9. A linked apron in accordance with any of the preceding claims, wherein the linked apron (2, 3) is provided with a further cover apparatus (5, 6).

10. A module (cover module) for a machine, in particular for a machine tool, having a frame (20) and a linked apron in accordance with any of the preceding claims.

11. A module in accordance with claim 10, characterised by a base plate (21) which can preferably be secured to the machine or machine tool.
